(19) United States
(12) Patent Application Publication
(10) Pub. No.: US 2016/0246366 A1
(43) Pub. Date: Aug. 25, 2016

(54) CONTROL METHOD AND CONTROL APPARATUS FOR ELECTRONIC EQUIPMENT AND ELECTRONIC EQUIPMENT

(71) Applicant: Sony Corporation, Tokyo (JP)

(72) Inventors: Di HUANG, Beijing (CN); Gang XU, Beijing (CN)

(21) Appl. No.: 14/890,245

(22) PCT Filed: Aug. 21, 2015
(86) PCT No.: PCT/IB2015/056353

§ 371 Date: Feb. 22, 2016

(30) Foreign Application Priority Data
Jan. 6, 2015 (CN) 201510005593.5

(51) Int. Cl. G06F 3/01

(52) U.S. Cl. CPC G06F 3/013

(57) ABSTRACT

Embodiments of the present disclosure provide a control method and apparatus for electronic equipment and electronic equipment. The control apparatus includes: a controlling unit configured to, when an operation of a user on a display screen of the electronic equipment corresponding to a first function is in a user's eye focus area, control the electronic equipment to execute a second function corresponding to the operation, the first function and the second function being identical or different. According to the embodiments, the electronic equipment may be controlled in conjunction with the user's eye focus area and the operation, thereby reflecting more accurately a manner desired by the user for controlling the electronic equipment.

### CROSS-REFERENCE TO RELATED APPLICATION AND PRIORITY CLAIM

This application claims the benefit of Chinese Patent Application Serial No. 201510005593.5, filed Jan. 6, 2015, the entire disclosure of which is hereby incorporated by reference.

### TECHNICAL FIELD

The present disclosure relates to electronic equipment, and in particular to a control method and control apparatus for electronic equipment and electronic equipment.

### BACKGROUND ART

As sciences and technologies develop, and people's living standard improves, electronic equipment, such as a smart mobile phone, and a tablet personal computer, etc., has become necessity to people's lives. When using the electronic equipment, a user often sends control instructions to the electronic equipment via a display screen. A relatively larger area of a display screen facilitates operations of users, and brings relatively better visual experiences to users.

It should be noted that the above description of the background art is merely provided for clear and complete explanation of the present disclosure and for easy understanding by those skilled in the art. And it should not be understood that the above technical solution is known to those skilled in the art as it is described in the background art of the present disclosure.

### SUMMARY

As the area of the display screen increases, the screen side frame of the electronic equipment is getting narrower, and the user is prone to incorrectly operate the display screen in holding the frame of the electronic equipment, thereby transmitting undesired control instructions to the electronic equipment. For example, in a case where the electronic equipment is playing video, when the user moves a position of the electronic equipment, a finger may unintentionally contact the display screen, thereby stopping the playing or changing a content of the playing.

Embodiments of the present disclosure provide a control method and control apparatus for electronic equipment and electronic equipment, with purpose being to control the electronic equipment in a more desired manner of the user.

According to a first aspect of the embodiments of the present disclosure, there is provided a control apparatus for electronic equipment, including: a controlling unit configured to, when an operation of a user on a display screen of the electronic equipment corresponding to a first function is in a user's eye focus area, control the electronic equipment to execute a second function corresponding to the operation.

As used herein the terms unit, module, etc. may be used equivalently and interchangeably, as will be apparent from the description and/or context.

According to a second aspect of the embodiments of the present disclosure, the first function and the second function are identical or different.

According to a third aspect of the embodiments of the present disclosure, the control apparatus further includes:

a first detecting unit configured to detect the user's eye focus area.

According to a fourth aspect of the embodiments of the present disclosure, the first detecting unit includes:

a focus detecting unit configured to detect a focus location of a sight line of the user on the display screen; and

an eye focus area determining unit configured to determine the user's eye focus area according to the focus location and a predefined size.

According to a fifth aspect of the embodiments of the present disclosure, the control apparatus further includes:

a size setting unit configured to set the size.

According to a sixth aspect of the embodiments of the present disclosure, the control apparatus further includes a second detecting unit configured to detect a rate of change of the user's eye focus area along with the time; and when the operation of the user on the display screen of the electronic equipment corresponding to the first function is in the user's eye focus area, the controlling unit controls the electronic equipment to execute the second function corresponding to the operation in a case where the rate of change of the user's eye focus area along with the time is less than a predefined threshold value.

According to a seventh aspect of the embodiments of the present disclosure, the controlling unit is further configured to, when the operation of the user on the display screen of the electronic equipment is out of the user's eye focus area, control the electronic equipment not to execute a function corresponding to the operation.

According to an eighth aspect of the embodiments of the present disclosure, there is provided electronic equipment, including the control apparatus as described in the first to the seventh aspects.

According to a ninth aspect of the embodiments of the present disclosure, there is provided a control method for electronic equipment, including: when an operation of a user on a display screen of the electronic equipment corresponding to a first function is in a user's eye focus area, controlling the electronic equipment to execute a second function corresponding to the operation.

According to a tenth aspect of the embodiments of the present disclosure, the control method further includes: detecting the user's eye focus area.

According to an eleventh aspect of the embodiments of the present disclosure, the detecting the user's eye focus area includes:

detecting a focus location of a sight line of the user on the display screen; and

determining the user's eye focus area according to the focus location and a predefined size.

According to a twelfth aspect of the embodiments of the present disclosure, the control method further includes:

setting the size.

According to a thirteen aspect of the embodiments of the present disclosure, the control method further includes detecting a rate of change of the user's eye focus area along with the time; and

when the operation of the user on the display screen of the electronic equipment corresponding to the first function is in the user's eye focus area, controlling the electronic equipment to execute the second function corresponding to the operation in a case where the rate of change of the user's eye focus area along with the time is less than a predefined threshold value.

According to a fourteenth aspect of the embodiments of the present disclosure, the control method further includes:

controlling the electronic equipment not to execute a function corresponding to the operation when the operation of the user on the display screen of the electronic equipment is out of the user's eye focus area.

An advantage of the embodiments of the present disclosure exists in that when the operation of the user on the display screen is in the user's eye focus area, the electronic equipment is controlled to execute a function corresponding to the operation, thereby controlling the electronic equipment in conjunction with the user's eye focus area and the operation, and reflecting more accurately a manner desired by the user for controlling the electronic equipment.

With reference to the following description and drawings, embodiments of the present disclosure are disclosed in detail, and the principles of the present disclosure and the manners of use are indicated. It should be understood that the scope of the present disclosure is not limited thereto. The embodiments of the present disclosure contain many alternations, modifications and equivalents within the spirit and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth principles of the present disclosure together with the description. It is obvious that the accompanying drawings and the following description are some embodiments of the present disclosure only, and a person of ordinary skill in the art may further obtain other drawings according to these accompanying drawings without making an inventive effort. In the drawings:

FIG. 1 is a schematic diagram of the structure of the control apparatus of Embodiment 1 of this application;

FIG. 2 is a schematic diagram of a scenario of Embodiment 1;

FIG. 3 is another schematic diagram of a scenario of Embodiment 1;

FIG. 4 is another schematic diagram of the structure of the control apparatus of Embodiment 1 of this application;

FIG. 5 is a schematic diagram of the structure of the detecting unit of Embodiment 1 of this application;

FIG. 6 is a block diagram of the systematic structure of the electronic equipment of Embodiment 2 of this application;

FIG. 7 is a flowchart of the control method of Embodiment 3 of this application; and

FIG. 8 is a flowchart of the method for detecting the user's eye focus area of Embodiment 3 of this application.

### DETAILED DESCRIPTION

Various embodiments of the present disclosure are described as follows with reference to the drawings. These embodiments are illustrative only, and are not intended to limit the present disclosure.

### Embodiment 1

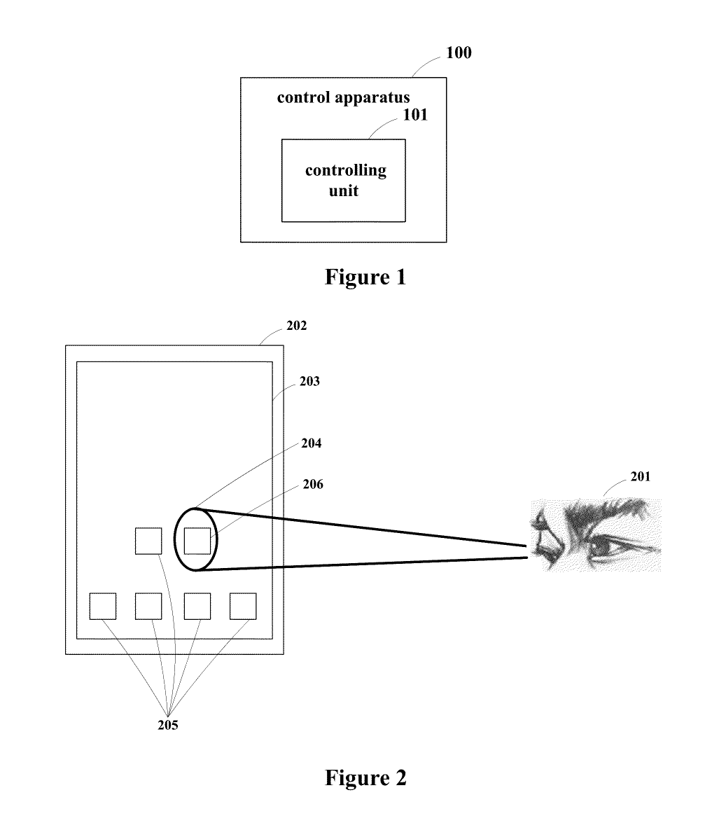

Embodiment 1 of this application provides a control apparatus for electronic equipment. FIG. 1 is a schematic diagram of the structure of the control apparatus of Embodiment 1 of this application. As shown in FIG. 1, the control apparatus 100 may include a controlling unit 101.

The controlling unit 101 is configured to, when an operation of a user on a display screen of the electronic equipment corresponding to a first function is in a user's eye focus area; control the electronic equipment to execute a second function corresponding to the operation.

According to this embodiment, when the operation of the user on the display screen is in the user's eye focus area, the electronic equipment is controlled to execute the function corresponding to the operation, thereby controlling the electronic equipment in conjunction with the user's eye focus area and the operation, and reflecting more accurately a manner desired by the user for controlling the electronic equipment.

In this embodiment, the operation of the user may be a touch-screen operation, and the touch-screen operation may include clicking a predefined area of the display screen, such as an icon displayed on the display screen; and may also include movement on the display screen by using a predefined gesture, such as an action of sliding, enlargement, or reducing, etc. However, this embodiment is not limited thereto, and the operation may further include other manners in the prior art, such as a non-contact suspension operation, or a gesture operation based on an infrared gesture identification technology, etc.

In this embodiment, the display screen may correspond to a manner of operation of the use for receiving an operation of the user, so as to generate control instructions to the electronic equipment. For example, when the operation of the user is a touch-screen operation, the display screen may be a touch display screen; and when the operation of the user is a suspension operation, the display screen may be a display screen supporting the suspension operation.

In this embodiment, the first function and the second function may be different. Therefore, for the same operation, in cases where the operation is in the user's eye focus area and the operation is not in the user's eye focus area, the electronic equipment executes different functions. Hence, the functions of the electronic equipment may be expanded. For example, when the first function may be clicking an icon of an application (APP) displayed on the display screen, a dialog box of whether opening the application is displayed on the display screen, and when the second function may be clicking an icon of an application displayed on the display screen, the application is opened directly. Of course, this embodiment is not limited thereto, and the first function and the second function may be other functions.

In this embodiment, the first function and the second function may be identical. Therefore, in a case where the operation is in the user's eye focus area, the electronic equipment executes a predefined function corresponding to the operation. Hence, in comparison with the case where a predefined function is executed according to the operation only, a manner desired by the user for controlling the electronic equipment may be reflected more accurately. For example, the first function may be that when the user clicks a function icon displayed on the display screen, the electronic equipment is made to execute a function corresponding to the function icon; or the first function may be that when the user performs a sliding operation in the display screen, a window displayed by the display screen is switched, etc. However, this embodiment is not limited thereto, and the first function and the second function may be other functions.

In this embodiment, the controlling unit 101 is further configured to, when the operation of the user on the display screen of the electronic equipment is out of the user's eye focus area, control the electronic equipment not to execute a function corresponding to the operation, thereby preventing the electronic equipment from being affected by an incorrect operation out of the user's eye focus area.

Furthermore, in this embodiment, in the case where the operation of the user on the display screen corresponding to the first function is out of the user's eye focus area, the electronic equipment may be controlled to execute a third function corresponding to the operation, according to the distance between the area of the operation and the user's eye focus area. The third function being identical to or different from the first function. For example, when the first function may be clicking an icon of an application (APP) displayed on the display screen, a dialog box of whether opening the application is displayed on the display screen; when a distance between the area of the operation and the user's eye focus area is less than a first threshold value, the third function corresponding to the operation may be set as being identical to the first function, and when the distance between the area of the operation and the user's eye focus area is greater than the first threshold value, the third function corresponding to the operation may be set as being different from the first function; for example, the third function may be that when an icon of an application displayed on the display screen is clicked, attribute information, or the like, of the application, is displayed on the display screen. In this way, the electronic equipment may be controlled according to the distance between the area of the operation and the user's eye focus area, thereby further expanding functions of the electronic equipment.

FIG. 2 is a schematic diagram of a scenario of this embodiment. As shown in FIG. 2, in a case where the user 201 focuses on the display screen 203 of the electronic equipment 202, the user's eye focus area is 204. If the user clicks an icon 205 out of the user's eye focus area, the display screen displays a dialog box representing whether to open or opening of the application; and if the user clicks an icon 206 in the user's eye focus area, the application is opened directly.

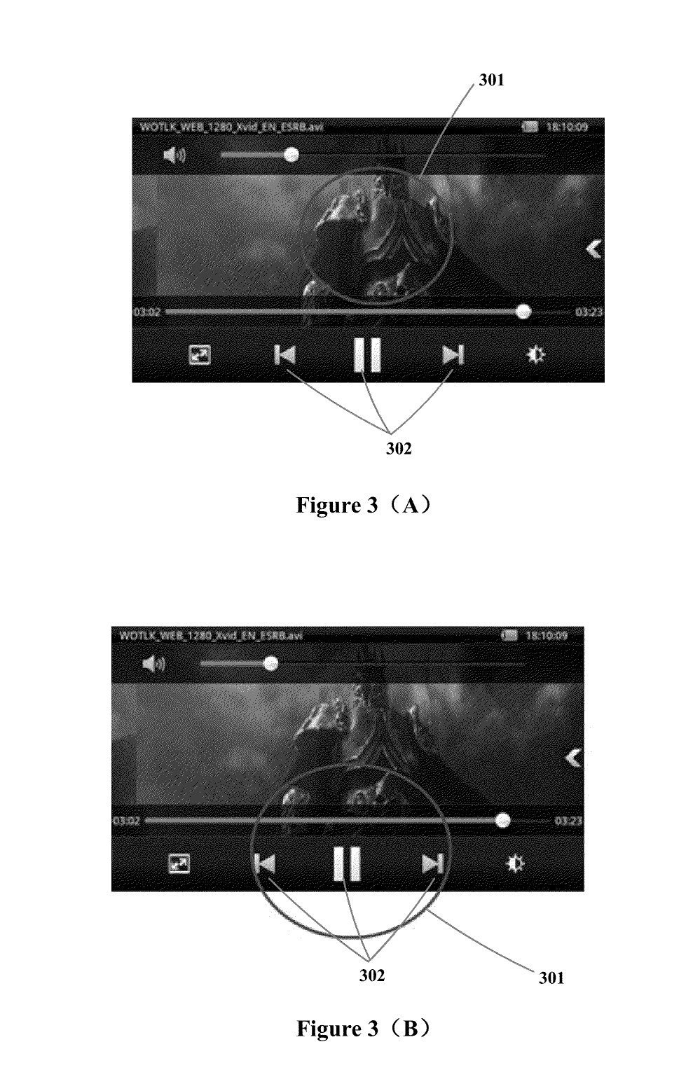

FIG. 3 is another schematic diagram of a scenario of this embodiment. As shown in FIG. 3(A), in a case where the electronic equipment is operating a video playing application, when the user is watching the video, the user's eye focus area 301 is located in a video playing area; and in a case where the user holds the electronic equipment and unintentionally clicks a function icon 302 located out of the user's eye focus area 301 due to adjusting a gesture or position of the electronic equipment, the electronic equipment does not execute a function corresponding to the function icon 302, thereby avoiding an incorrect operation on the electronic equipment. As shown in FIG. 3(B), when the user desires to operate for a function icon, the user's eye focus area 301 will be moved to the function icon 302. Hence, when the user clicks the function icon 302 located in the user's eye focus area 301, the electronic equipment will execute the function corresponding to the function icon 302, such as a function of pause/continuation, playing a former video or playing a next video, etc.

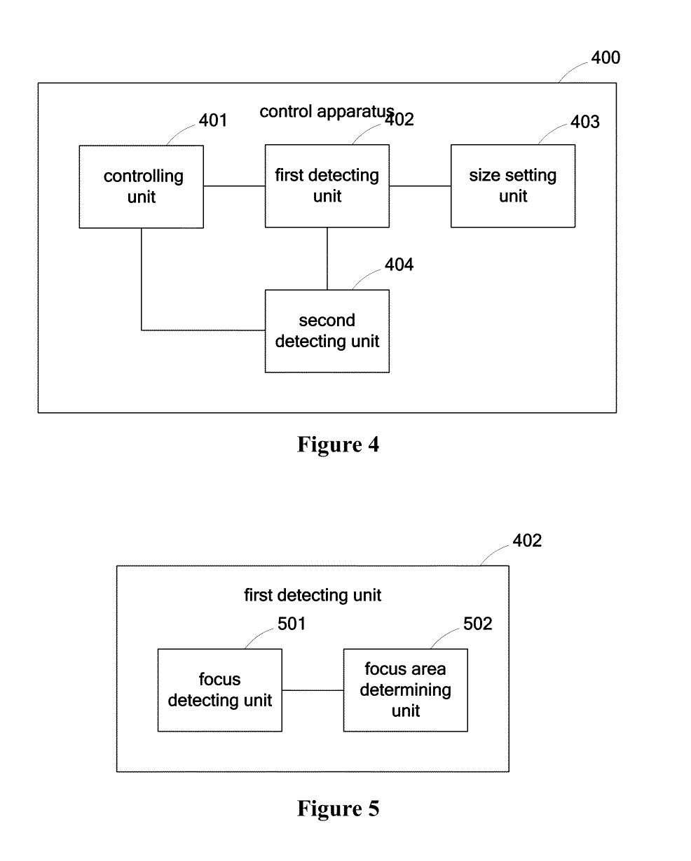

FIG. 4 is another schematic diagram of the structure of the control apparatus of Embodiment 1 of this application. As shown in FIG. 4, the control apparatus 400 may include a controlling unit 401 and a first detecting unit 402.

The function of the controlling unit 401 is identical that of the controlling unit 101 shown in FIG. 1, which shall not be described herein, and the first detecting unit 402 is configured to detect the user's eye focus area.

FIG. 5 is a schematic diagram of the structure of the detecting unit of Embodiment 1 of this application. As shown in FIG. 5, the first detecting unit 402 includes a sight line focus detecting unit 501 and an eye focus area determining unit 502.

The focus detecting unit 501 is configured to detect a focus location of a sight line of the user on the display screen, and the eye focus area determining unit 502 is configured to determine the user's eye focus area according to the focus location and a predefined size. The eye focus area determining unit 502 may analyze an image of the face of the user captured by a camera of the electronic equipment in a real-time manner, so as to detect a location of a pupil and the sight line of the user; and a distance between eyes of the user and the electronic equipment when the user operates the electronic equipment may be predefined according to an operational habit of the user, or a standard image of the face of the user captured by the camera of the electronic equipment may be stored in advance under a standard distance, such as 1 meter, the image of the face of the user captured by the camera of the electronic equipment in a real-time manner is compared with the standard image of the face of the user, and the distance between eyes of the user and the electronic equipment when the user operates the electronic equipment is estimated according to a comparison result and the standard distance.

In this embodiment, the focus detecting unit 501 may determine the focus location of the sight line of the user on the display screen according to the above more than two images of the face of the user, thereby determining more exactly the focus location. Furthermore, the more than two images of the face of the user may be obtained by two cameras of the electronic equipment in a real-time manner.

The above description is illustrative only, and the sight line focus detecting unit may detect the focus location of the sight line of the user on the display screen in other methods, such as an eye ball tracking method. For example, the electronic equipment emits a light beam, such as an infrared ray, etc., to irises of the user, and calculates the focus location of the sight line of the user on the display screen according to a reflected beam.

In this embodiment, the eye focus area determining unit 502 may take the focus location detected by the focus detecting unit 501 as the center of the user's eye focus area, and determine the user's eye focus area according to the predefined size.

In this embodiment, a shape and size of the user's eye focus area may be determined by the above size. For example, when the shape of the user's eye focus area is set as a circular shape, a square shape, an ellipsoidal shape or a triangular shape, the size may correspond to a radius of the circular shape, a side length of the square shape, a long axis and a short axis of the ellipsoidal shape or side lengths of the triangular shape, thereby determining the location, shape and size of the user's eye focus area according to the location of the focus and the size.

In this embodiment, as shown in FIG. 4, the controlling unit 400 may set the size according to input of the user.

In this embodiment, the size setting unit 403 may set the size according to use habits of the electronic equipment popular to users obtained through analysis of use records of multiple users, or according to a habit of the electronic equipment of a single user obtained through analysis of use records of the single user. For example, the size setting unit 403 may set the size according to a range of contact of a finger of the user and the display screen in clicking the display screen by the user obtained through big data analysis.

In this embodiment, the size setting unit 403 may also set the size according to an operational status of an application operated by the electronic equipment. For example, when the electronic equipment is playing a video in a full-screen manner, the size setting unit 403 may set the size to be relatively small, so as to lower a probability of affecting the play of the video due to an incorrect operation.

Furthermore, in this application, the size setting unit 403 may acquire the operational status of the application in a manner of reading an operation log of the electronic equipment, and may also acquire the operational status of the application according to a detection result of a physiological parameter of the user. For example, when the size setting unit 403 acquires physiological parameters, such as temperature rise and/or pulse acceleration, of the user, it is judged that the user is watching an interesting video or picture by using the electronic equipment. Hence, the size setting unit 403 is set relatively small in size, so as to lower a probability of affecting the user in watching the interested video or picture due to an incorrect operation. In this embodiment, a physiological parameter of the user may be acquired in multiple manners in the prior art, which shall not be described any further in this embodiment.

In this embodiment, as shown in FIG. 4, the controlling unit 400 may further include a second detecting unit 404 configured to detect a rate of change of the location of the user's eye focus area along with the time. For example, the second detecting unit 404 may detect the rate of change of the focus location along with the time detected by the sight line focus detecting unit 501, so as to take it as the rate of change of the location of the user's eye focus area along with the time. Of course, the second detecting unit 404 may perform the detection in other manners.

In this embodiment, when the second detecting unit 404 detects that the rate of change of the location of the user's eye focus area along with the time is less than a predefined threshold value, it may be deemed that the user focuses on a specific area on the display screen intentionally, but does not sweep the display screen unintentionally. Hence, in such a case, when the operation of the user on the display screen of the electronic equipment corresponding to the first function is in the user's eye focus area, the controlling unit 401 controls the electronic equipment to execute the second function corresponding to the operation. Therefore, a manner desired by the user for controlling the electronic equipment may be reflected more accurately and reliably, and avoiding an incorrect operation due to sweeping the display screen unintentionally or contacting the display screen unintentionally by the user.

According to this embodiment, when the operation of the user on the display screen is in the user's eye focus area, the electronic equipment is controlled to execute the function corresponding to the operation, thereby controlling the electronic equipment according to the user's eye focus area and the operation, and reflecting more accurately a manner desired by the user for controlling the electronic equipment; and when the operation is out of the user's eye focus area, the electronic equipment is controlled not to execute the function corresponding to the operation, thereby preventing the operation of the electronic equipment from being affected by incorrect touch. Furthermore, the first function and the second function may be different, thereby expanding functions of the electronic equipment. Furthermore, the size of the user's eye focus area may be set according to input of the user. And furthermore, the second function corresponding to the operation in the user's eye focus area is executed only when the rate of change of the location of the user's eye focus area is relatively small, thereby avoiding an incorrect operation due to sweeping the display screen unintentionally or contacting the display screen unintentionally by the user.

### Embodiment 2

An embodiment of this application further provides electronic equipment, including the control apparatus as described in Embodiment 1.

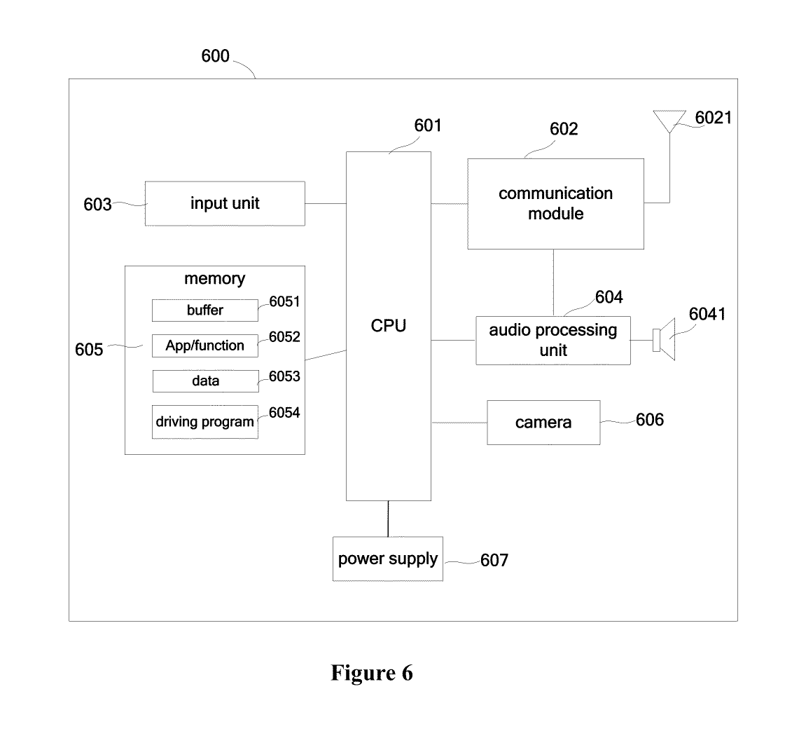

FIG. 6 is a block diagram of the systematic structure of the electronic equipment of an embodiment of this application, including the control apparatus as described in Embodiment 1. It should be noted that such a figure is exemplary only, and other types of structures may be used to supplement or replace this structure for the realization of telecommunications functions or other functions.

As shown in FIG. 6, the electronic equipment 600 may include a central processing unit 601, a communication module 602, an input unit 603, an audio processing unit 604, a memory 605, a camera 606, and a power supply 607.

The central processing unit 601 (which is sometimes referred to as a controller or control, and may include a microprocessor or other processor devices and/or logic devices) receives input and controls each part and operation of the electronic equipment 600. The input unit 603 provides input to the central processing unit 601. The input unit 603 may be for example a display screen, such as a touch display screen.

In this embodiment, the central processing unit 601 is configured to, when an operation of a user on a display screen of the electronic equipment corresponding to a first function is in a user's eye focus area, control the electronic equipment to execute a second function corresponding to the operation; wherein, the first function and the second function are identical or different.

Furthermore, the central processing unit 601 is configured to, when the operation of the user on the display screen of the electronic equipment is out of the user's eye focus area, control the electronic equipment not to execute a function corresponding to the operation.

Furthermore, the central processing unit 601 is configured to detect a focus location of a sight line of the user on the display screen, and determine the user's eye focus area according to the focus location and a predefined size.

Furthermore, the central processing unit 601 is configured to set the size, e.g., as was described above with respect to Embodiment 1.

Furthermore, the central processing unit 601 is configured to detect a rate of change of the location of the user's eye focus area along with the time, and when the operation of the user on the display screen of the electronic equipment corresponding to the first function is in the user's eye focus area, control the electronic equipment to execute the second function corresponding to the operation in a case where the rate of change of the user's eye focus area along with the time is less than a predefined threshold value.

In this embodiment, the communication module 602 is a transmitter/receiver transmitting and receiving signals via an antenna 6021. The communication module (transmitter/receiver) 602 is coupled to the central processing unit 601 to provide input signals and receive output signals, this being similar to the case in a conventional mobile communication terminal.

A plurality of communication modules 602 may be provided in the same electronic equipment for various communication technologies, such a cellular network module, a Bluetooth module, and/or wireless local network module, etc. The communication module (transmitter/receiver) 602 is also coupled to a loudspeaker 6041 via the audio processing unit 604, for providing audio output via the loudspeaker 6041. The audio processing unit 604 may further include any suitable buffer, decoder, and amplifier, etc.

In this embodiment, the camera 606 is used to take image data and provide the taken image data to the central processing unit 601 for use in a conventional manner, for example, for storage, and transmission, etc. And the power supply 607 is used to supply power to the electronic equipment 600.

The memory 605 is coupled to the central processing unit 601, and may be a solid state memory, such as a read-only memory (ROM), a random access memory (RAM), and a SIM card, etc., and may also be such a memory that stores information when the power is interrupted, may be optionally erased and provided with more data.

Examples of such a memory are sometimes referred to as an EPROM, etc. The memory 605 may also be certain other types of devices. The memory 605 includes a buffer memory 6051 (sometimes referred to as a buffer). The memory 605 may include an application/function storing portion 6052 used to store application programs and function programs, or to execute the flow of the operation of the electronic equipment 600 via the central processing unit 601.

The memory 605 may further include a data storing portion 6053 used to store data, such as the predefined size in Embodiment 1 of this application. A driver storing portion 6054 of the memory 605 may include various types of drivers of the electronic equipment for the communication function and/or for executing other functions (such as application of message transmission, and application of directory, etc.) of the electronic device.

### Embodiment 3

Embodiment 3 of this application provides a control method for electronic equipment, corresponding to the control apparatus in Embodiment 1, with the contents identical to those in Embodiment 1 being not going to be described any further.

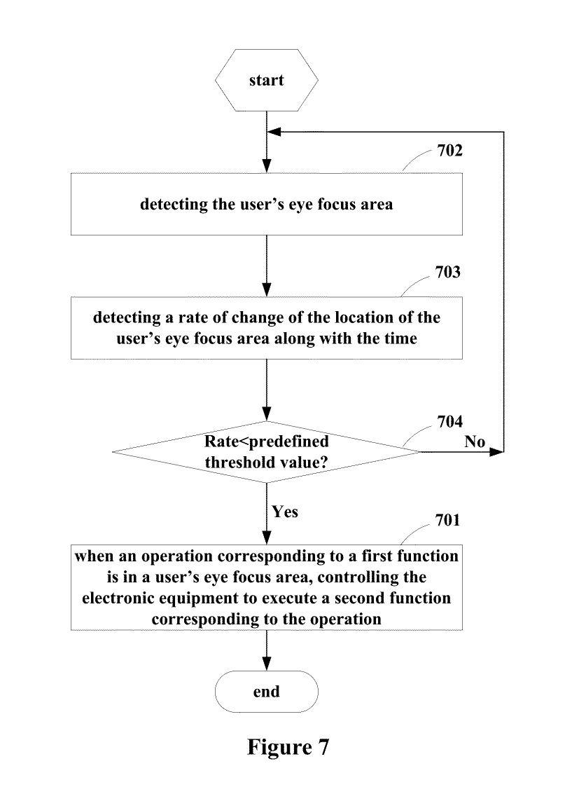

FIG. 7 is a flowchart of the control method of Embodiment 3 of this application. As shown in FIG. 7, the control method includes:

Step 701: when an operation of a user on a display screen of the electronic equipment corresponding to a first function is in a user's eye focus area, controlling the electronic equipment to execute a second function corresponding to the operation.

In this embodiment, the first function and the second function are identical or different.

Furthermore, in this embodiment, when the operation of the user on the display screen of the electronic equipment is out of the user's eye focus area, the electronic equipment is controlled not to execute a function corresponding to the operation.

Furthermore, as shown in FIG. 7, the control method may further include:

Step 702: detecting the user's eye focus area;

Step 703: detecting a rate of change of the location of the user's eye focus area along with the time; and

Step 704: judging whether the rate of change of the location of the user's eye focus area along with the time is less than a predefined threshold value, and executing step 701 when it is judged “yes”.

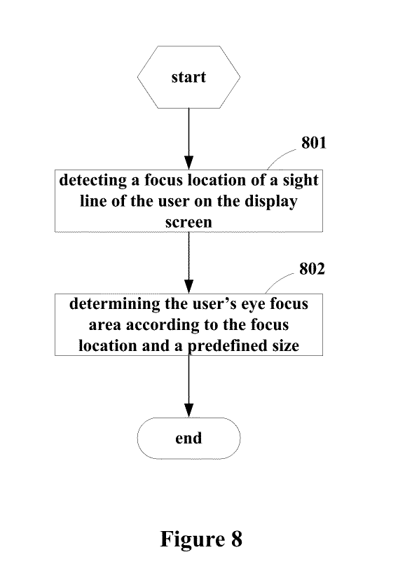

FIG. 8 is a flowchart of the method for detecting the user's eye focus area of Embodiment 3 of this application. As shown in FIG. 8, the method may include:

Step 801: detecting a focus location of a sight line of the user on the display screen; and

Step 802: determining the user's eye focus area according to the focus location and a predefined size.

In this embodiment, the particular operational manners of corresponding units in Embodiment 1 may be referred to for particular operational manners of the above steps, which shall not be described herein any further.

According to this embodiment, when the operation of the user on the display screen is in the user's eye focus area, the electronic equipment is controlled to execute the function corresponding to the operation, thereby controlling the electronic equipment according to the user's eye focus area and the operation, and reflecting more accurately a manner desired by the user for controlling the electronic equipment.

An embodiment of the present disclosure further provides a computer-readable program, wherein when the program is executed in electronic equipment, the program enables the computer to carry out the control method as described in Embodiment 1 in the electronic equipment.

An embodiment of the present disclosure further provides a storage medium in which a computer-readable program is stored, wherein the computer-readable program enables the computer to carry out the control method as described in Embodiment 1 in electronic equipment.

The preferred embodiments of the present disclosure are described above with reference to the drawings. The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

It should be understood that each of the parts of the present disclosure may be implemented by hardware, software, firmware, or a combination thereof In the above embodiments, multiple steps or methods may be realized by software or firmware that is stored in the memory and executed by an appropriate instruction executing system. For example, if it is realized by hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of comprising one or more modules, segments or parts for realizing the codes of executable instructions of the steps in specific logic functions or processes, and that the scope of the preferred embodiments of the present disclosure comprise other implementations, wherein the functions may be executed in manners different from those shown or discussed, including executing the functions according to the related functions in a substantially simultaneous manner or in a reverse order, which should be understood by those skilled in the art to which the present disclosure pertains.

The logic and/or steps shown in the flowcharts or described in other manners here may be, for example, understood as a sequencing list of executable instructions for realizing logic functions, which may be implemented in any computer readable medium, for use by an instruction executing system, device or apparatus (such as a system including a computer, a system including a processor, or other systems capable of extracting instructions from an instruction executing system, device or apparatus and executing the instructions), or for use in combination with the instruction executing system, device or apparatus.

The above literal description and drawings show various features of the present disclosure. It should be understood that a person of ordinary skill in the art may prepare suitable computer codes to carry out each of the steps and processes described above and illustrated in the drawings. It should also be understood that the above-described terminals, computers, servers, and networks, etc. may be any type, and the computer codes may be prepared according to the disclosure contained herein to carry out the present disclosure by using the devices.

Particular embodiments of the present disclosure have been disclosed herein. Those skilled in the art will readily recognize that the present disclosure is applicable in other environments. In practice, there exist many embodiments and implementations. The appended claims are by no means intended to limit the scope of the present disclosure to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present disclosure has been described, it is understood that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. A control apparatus for electronic equipment, characterized in that the control apparatus comprises:
a controlling unit configured to, when an operation of a user on a display screen of the electronic equipment corresponding to a first function is in a user's eye focus area, control the electronic equipment to execute a second function corresponding to the operation.

2. The control apparatus according to claim 1, characterized in that the first function and the second function are identical or different.

3. The control apparatus according to claim 1, characterized in that the control apparatus further comprises:
a first detecting unit configured to detect the user's eye focus area.

4. The control apparatus according to claim 3, wherein the first detecting unit comprises:
a focus detecting unit configured to detect a focus location of the user's sight line on the display screen; and
an eye focus area determining unit configured to determine the user's eye focus area according to the focus location and a predefined size.

5. The control apparatus according to claim 4, wherein the control apparatus further comprises:
a size setting unit configured to set the size.

6. The control apparatus according to claim 1, wherein the control apparatus further comprises a second detecting unit configured to detect a rate of change of the location of the user's eye focus area along with the time;
and when the operation of the user on the display screen of the electronic equipment corresponding to the first function is in the user's eye focus area, the controlling unit controls the electronic equipment to execute the second function corresponding to the operation in a case where the rate of change of the user's eye focus area along with the time is less than a predefined threshold value.

7. The control apparatus according to claim 1, wherein,
the controlling unit is further configured to, when the operation of the user on the display screen of the electronic equipment is out of the user's eye focus area, control the electronic equipment not to execute a function corresponding to the operation.

8. Electronic equipment, comprising the control apparatus as claimed in claim 1.

9. A control method for electronic equipment, characterized in that the control method comprises:
when an operation of a user on a display screen of the electronic equipment corresponding to a first function is in a user's eye focus area, controlling the electronic equipment to execute a second function corresponding to the operation.

10. The control method according to claim 9, characterized in that the first function and the second function are identical or different.

11. The control method according to claim 9, characterized in that the control method further comprises:
detecting the user's eye focus area.

12. The control method according to claim 11, wherein the detecting the user's eye focus area comprises:
detecting a focus location of a sight line of the user on the display screen; and
determining the user's eye focus area according to the focus location and a predefined size.

13. The control method according to claim 12, wherein the control method further comprises:
setting the size.

14. The control method according to claim 9, wherein the control method further comprises detecting a rate of change of the user's eye focus area along with the time; and
when the operation of the user on the display screen of the electronic equipment corresponding to the first function is in the user's eye focus area, controlling the electronic equipment to execute the second function corresponding to the operation in a case where the rate of change of the user's eye focus area along with the time is less than a predefined threshold value.

15. The control method according to claim 9, wherein the control method further comprises:
controlling the electronic equipment not to execute a function corresponding to the operation when the operation of the user on the display screen of the electronic equipment is out of the user's eye focus area.

16. Electronic equipment, comprising the control apparatus as claimed in claim 7.

17. The control method according to claim 10, wherein the control method further comprises:
controlling the electronic equipment not to execute a function corresponding to the operation when the operation of the user on the display screen of the electronic equipment is out of the user's eye focus area.

18. The control method according to claim 11, wherein the control method further comprises:
controlling the electronic equipment not to execute a function corresponding to the operation when the operation of the user on the display screen of the electronic equipment is out of the user's eye focus area.

19. The control method according to claim 12, wherein the control method further comprises:
controlling the electronic equipment not to execute a function corresponding to the operation when the operation of the user on the display screen of the electronic equipment is out of the user's eye focus area.

20. The control method according to claim 14, wherein the control method further comprises:
controlling the electronic equipment not to execute a function corresponding to the operation when the operation of the user on the display screen of the electronic equipment is out of the user's eye focus area.
